(19) United States
(12) Patent Application Publication
(10) Pub. No.: US 2025/0284894 A1
(43) Pub. Date: Sep. 11, 2025

(54) SYSTEM AND METHOD FOR COLLECTING AND MANAGING CONTEXTUAL DATA RELATED TO ACTIVITY OF AI AGENTS IN AN COMPUTER EXECUTION ENVIRONMENT

(71) Applicant: Futureverse IP Limited, Auckland (NZ)

(72) Inventor: David McDonald, Auckland (NZ)

(21) Appl. No.: 19/071,445

(22) Filed: Mar. 5, 2025

Related U.S. Application Data
(63) Continuation-in-part of application No. 18/792,272, filed on Aug. 1, 2024.
(63) Continuation-in-part of application No. 18/933,693, filed on Oct. 31, 2024, now Pat. No. 12,353,855.
(60) Provisional application No. 63/561,557, filed on Mar. 5, 2024.

(51) Int. Cl. G06F 40/35

(52) U.S. Cl. CPC G06F 40/35

(57) ABSTRACT

An AI agent is associated with a contextual memory configured to store contextual data related to the agent's activity and interactions with other elements in a computing environment. These interactions and experiences are transferable with the AI agent across multiple execution environments. The contextual data can influence the AI agent's interactions within these environments. The contextual memory may comprise multiple cards, each containing data representing an interaction or attribute of a specific asset within the environment. The data on the cards can include intrinsic information, dynamic information, and event/interaction information related to the specific asset.

### RELATED APPLICATION DATA

This application is a Continuation-in-Part of U.S. application Ser. No. 18/792,272 filed on 1 Aug. 2024 and application Ser. No. 18/933,693 filed on 31 Oct. 2024 and claims priority to U.S. Provisional App. Ser. No. 63/561,557 filed on 5 Mar. 2024, the entire disclosures of which are incorporated herein by reference.

### FIELD OF THE INVENTION

The present disclosure generally relates to the management of artificial intelligence (AI) agents in an execution environment, such as a metaverse environment, an online game environment, and a financial services computing environment, and more specifically, to systems, methods, and devices that associate AI agents with a contextual memory for storing contextual data relating to the activity of the agent and interactions with other assets within various environments.

### BACKGROUND

Artificial Intelligence (AI) has become a cornerstone of modern technology, with applications spanning various fields, from healthcare to entertainment. One of the emerging applications of AI is in the realm of virtual environments, such as “metaverse environments”. “Metaverse refers to a collective virtual shared space where users can interact with a computer-generated environment and other digital assets, such as other users, in real-time.

In the metaverse, AI models (also referred to as “AIs” and “agents” herein) play a pivotal role. These agents are autonomous entities, such as characters represented by an avatar, that observe their environment and make decisions based on their observations to achieve specific goals. For example, the agent can be a game player in a metaverse game or a member of another online community. In other examples, the agent can be a Non Player Character (NPC), a financial services bot, a chatbot, or the like. The phrase “AI Agent”, as used herein, refers to a digital asset that includes an artificial intelligence model (AI model). The AI model can include an artificial neural network (ANN) or another AI architecture.

### SUMMARY OF INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Disclosed implementations introduce the concept of contextual memory, which refers to the ability of an AI agent to store and recall information about its past experiences, such as interactions other agents or other digital assets. This memory can influence the agent's future behaviors and decision-making processes. For example, an AI agent might alter its behavior based on past interactions with a particular user or object in one or more execution environments. Execution environments refer to the platforms or systems where the AI agents execute/operate. These environments can include virtual reality (VR), augmented reality (AR), traditional gaming platforms, and other digital spaces.

According to an aspect of the present disclosure, a computer-implemented method for managing artificial intelligence (AI) agents in a metaverse environment includes creating artificial intelligence (AI) agents for execution in one or more execution environments, the method comprising: associating an AI agent with a non-fungible token (NFT); linking the AI model with a value matrix that defines attributes of the AI agent; and linking a contextual memory to the AI agent, wherein the contextual memory is configured to store contextual data relating to experiences of the AI agent in an execution environment, whereby the experiences are transferable with the AI agent across multiple execution environments.

The foregoing general description of the illustrative embodiments and the following detailed description thereof are merely exemplary aspects of the teachings of this disclosure and are not restrictive.

### BRIEF DESCRIPTION OF THE DRAWING

FIG. 1 is a block diagram of an AI agent in accordance with disclosed implementations.

FIG. 2 Illustrates details of a contextual memory and memory manger in accordance with disclosed implementations.

FIG. 3 is a flow chart of a method for using contextual data in accordance with disclosed implementations.

FIG. 4 illustrates a computer architecture in accordance with disclosed implementations.

FIG. 5 illustrates a computer architecture in accordance with disclosed implementations in which a contextual memory is shared by multiple AI agents.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

U.S. Pat. No. 11,797,274 teaches associating NFTs with AI models to provide a mechanism for ownership of the AI model and the use of a “value matrix” in the context of AI that defines attributes or characteristics of an AI agent. These attributes can include skills, appearance, knowledge, performance metrics, and user-defined characteristics. These concepts are leveraged, and expanded upon, in the disclosed implementations.

The present disclosure relates to systems, methods, and computer-readable media for managing artificial intelligence (AI) agents in computing environments, such as metaverse environments. In some aspects, the present disclosure provides a computer-implemented method and system for associating an AI agent with a non-fungible token (NFT), and linking a contextual memory to the AI agent. The contextual memory is configured to store contextual data relating to the experiences of the AI agent, such as interactions of the AI agent with other elements in one or more execution environments. The contextual data allows experiences to be transferable with the AI agent across multiple execution environments, thereby enhancing the user experience in the computing environment.

Disclosed implementations also leverage concepts of “adaptive AI”, which refers to an artificial intelligence agent that is capable of learning as it encounters changes, both in data and the environment in which it operates. However, disclosed implementations can retain data across different environments, i.e., the data layer is accessible in any digital sphere. While conventional adaptative AI models are trained programmatically to interpret and adapt to new information, disclosed implementations include a data layer that provides any AI Agent with contextual data and information to understand, interpret and adapt to interactions and events in various dynamic environments.

Disclosed implementations allow the AI agent to utilize the contextual memory to store data about its past experiences, such as activities and interactions. This data can include information about the agent's environment, events it has participated in, and its interactions with other users or AI agents. The AI agent may use the stored contextual data to modify its behavior in future interactions. For example, if an AI agent has a negative interaction with a particular user or object, it may avoid similar interactions in the future, or if it has a positive interaction, it may seek out similar experiences.

Disclosed implementations maintain learned behaviors and adaptations when transferred across multiple execution environments. This means that the AI agent can retain its experiences from one virtual space when moving to another, allowing for a consistent and evolving personality or set of behaviors across execution environments. The contextual memory can be persistently coupled to the AI agent to influence emergent behaviors based on the stored data. This suggests that the AI agent's decision-making processes are not static but can evolve as the contextual memory grows and changes.

The disclosed implementations provide an AI agent that is not just reactive to its immediate environment but is capable of complex behaviors that are shaped by a history of accumulated experiences, which are stored in a structured format (e.g., a schema or ontology) within the contextual memory. This allows the AI agent to exhibit a form of virtual learning and growth, akin to a living entity.

The contextual memory may comprise a plurality of “cards”, each card containing data representing an interaction or attribute of a specific asset within at least one of the multiple execution environments. The data on the cards may include intrinsic information, dynamic information, and event/interaction information related to the specific asset.

The cards may follow a specific, standardized format containing information that the asset provides to the AI during interactions. This card data can contribute to the pretext of the prompt, factoring in the distance between the asset (which can be an agent) and the agent, with a designated level of importance. Each card can also include a field to declare interactions with other assets. This structured format of the cards allows for a consistent and organized representation of the asset's attributes and interactions within the system and across disparate computing environments.

The structure and content of the cards in the contextual memory are designed to encapsulate detailed metadata about each interaction, including the object's biotags, the nature of the interaction (e.g., dialogue, combat, transaction), and the emotional or contextual significance. These cards serve as dynamic memory units, continuously updated, and expanded with new interactions and experiences. They enable the AI agent to recall past interactions, predict future behaviors, and adjust its actions, accordingly, ensuring a rich, evolving narrative driven by agent actions and interactions within the execution environment.

The system may include a non-fungible token (NFT) module, a contextual memory management module, and a contextual memory module. The NFT module is configured to associate AI agents with NFTs and enable transfer of ownership of the AI agents in a known manner. An input value matrix module can define attributes of the AI agents that can be interpreted across multiple metaverse applications. This value matrix may include a variety of parameters or characteristics that define the AI agent, such as its skills, abilities, knowledge, appearance, performance metrics, or other user-defined characteristics. The values in the input value matrix can be mapped to inputs of the AI model of the agent. Accordingly, the input value matrix may serve as a comprehensive profile (akin DNA) for the AI agent, providing a detailed and customizable representation of the AI agent's capabilities and attributes. For example, in a game, one or more values of the value matrix can specify the speed of the player/AI Agent.

The NFT may serve as a digital certificate of ownership for the AI agent, establishing a clear and verifiable record of ownership that can be transferred between users within the metaverse environment. This transferability of ownership may enable users to buy, sell, or trade AI agents in a secure and transparent manner, thereby enhancing the user experience and fostering a dynamic and vibrant marketplace for AI agents within the metaverse.

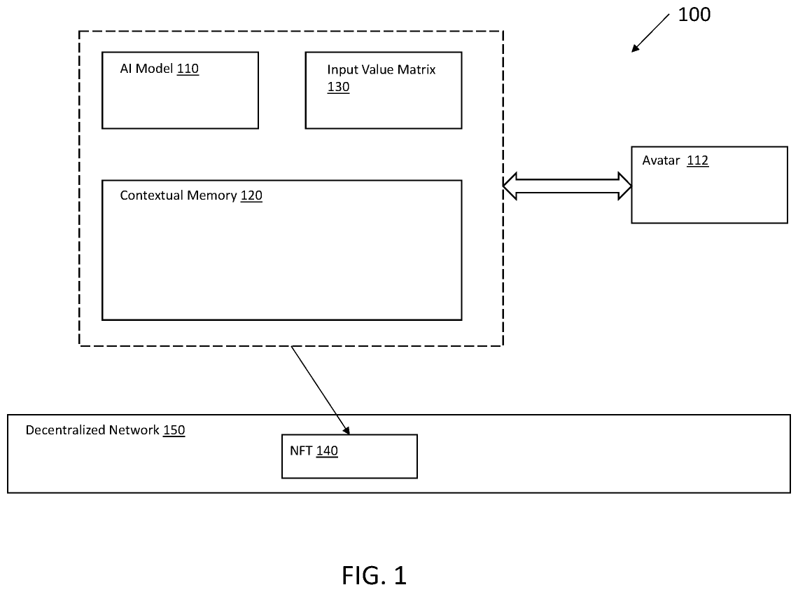

FIG. 1 illustrates a data structure of an agent in accordance with disclosed implementations. The data structure can be stored on non-transient computer readable media, such as a hard drive (spinning or solid state) optical media, or the like. Data structure 100 includes AI model 110, avatar 112, input value matrix 130, contextual memory 120 (storing the above-described cards), and Non-Fungible Token (NFT) 140. In this example, activity of avatar 112 within an execution environment (such as a metaverse game) is controlled by AI Model 110. However, the agent can relate to any entity and need not include an avatar. The elements need not be recorded on the same media. For example, they can be linked to one another through pointers, or by being stored in association with one another in a relational database. For example, in FIG. 1, NFT 140 is shown as being stored on a remote decentralized network (such as a blockchain) and associated with the other elements through a pointer. Each element of the data structure can be stored as a “module”, i.e., a set of data and/or instructions that, when processed in an execution environment, accomplishes the corresponding functions.

The cards stored in contextual memory 120 may be comprised of three distinct categories of data. The first level, referred to as intrinsic information, pertains to constant information inherent in the asset, such as a description of the object or general details transmitted to the AI agent. The intrinsic information can include detailed bio-tags that encapsulate the object's history, emotional significance, contextual importance, events and interactions over time.

The second level, known as dynamic information, refers to information that can be added or modified by the user or the asset's owner. The third level, known as event/interaction information, encompasses details about how the asset interacts with other assets and the outcomes transmitted to the player and AI during those interactions or events. For instance, consider a chest with a hidden treasure that requires a key for opening. The intrinsic information includes the chest's exterior details, while the event/interaction information reveals the hidden content when a specific interaction, such as a user using a virtual “key” to open the chest, occurs.

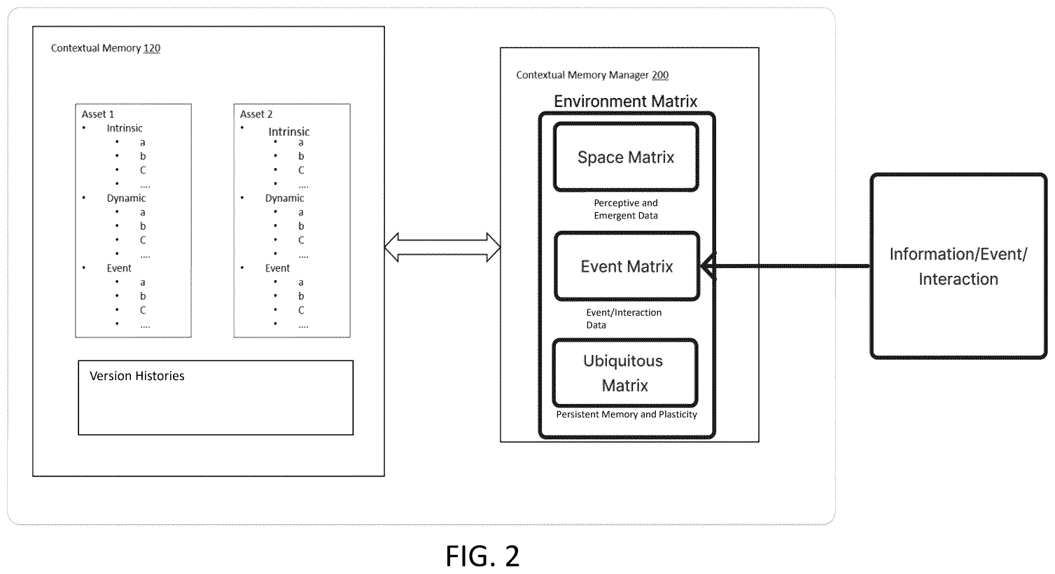

FIG. 2 schematically illustrates contextual memory 120, and the operation thereof, in more detail. Contextual memory 120 can be a database or other data structure. In the example of FIG. 2, contextual memory 120 stores contextual data in a predetermined ontology as the above-noted cards. Each card corresponds to an asset and thus includes data transmitted from and/or related to that asset. Only 2 cards are illustrated in FIG. 2 for simplicity. However, there can many cards depending on how many assets with which the AI model will potentially interact. Further, version histories of each card can be stored in contextual memory 120. In this simple example, the ontology is a tree-like structure and includes top level categories of Intrinsic, dynamic, and event. Intrinsic, Dynamic and Event data can be stored primarily in the card as a source of truth. All elements have the potential to be transferred to any agent interacting with a given card (or second/third hand from other agents possessing that information), depending on the depth of interaction and perception of those interactions.

Sub-categories are labeled as a, b, and c for simplicity in FIG. 2. Of course, there can be any number of subcategories of each category and any number of levels of categories and subcategories as need to express the context in any specific application. The specific design of the cards and contextual memory 120 for any specific application will be apparent to one of skill in the art based on the disclosure herein.

Contextual memory manager 200 can be an element of the execution environment, or can be provided as a service, and can apply rules and/or AI algorithms to select relevant contextual data to be stored in contextual memory 120 based on experiences of the agent. The experiences can include receipt of information, an event in the execution environment or an interaction of the corresponding agent within the execution environment. Contextual memory manager 200 can include an environment matrix capable of operating in 3 modes-a space matrix mode, an event matrix mode, and a ubiquitous matrix mode. These modes are described in more detail below.

For example, the contextual data can be used to simulate personal interpretation or perception of events as related to an Agents intrinsic characteristics and contextual history or recognize an emotional rating and importance factor for the information being perceived (such as, tone of voice, visual facial animation or expression, in addition to emotive language processing to interpret emotion) in addition to environmental context and spatial understanding to determine importance. This provides a threshold by which contextual memory manager 200 corresponding to a specific agent may choose to store or retrieve relevant memories and information, and to what extent that information might be recorded or retained as part of the contextual memory data. Further, memory manager 200 can provide plasticity and pruning or reinforcement of memories based on importance. As memories become less relevant or over time receive no trigger to be recalled or contextually considered, they may decay, or be pruned in accordance with one or more memory plasticity algorithms.

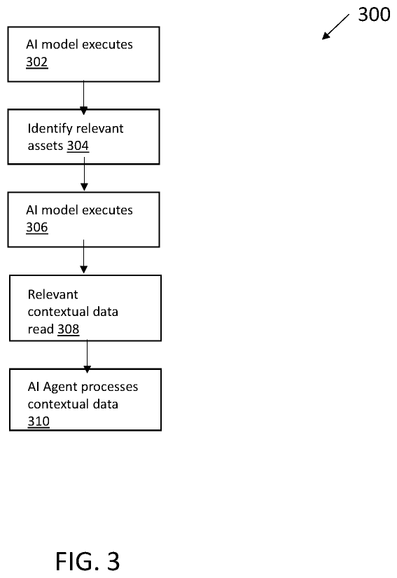

FIG. 3 illustrates a process of collecting and applying contextual data. Process 300 can begin with AI model 110 of the AI agent executing to cause avatar 112 to accomplish some sort of activity, such as enter a room, in step 302. At step 304 contextual memory manager 200 identifies relevant assets, such as other avatars in the room, and records contextual data associated with the assets into contextual memory 120 of AI agent 100. The data is stored in the contextual memory in accordance with the predefined ontology. At step 306, AI model 110 continues to execute. At step 308, relevant contextual data is mapped to inputs of the AI model to influence the behavior of avatar 112. The contextual data can be input into AI model 110 as training data and/or as independent input data in an inference operation.

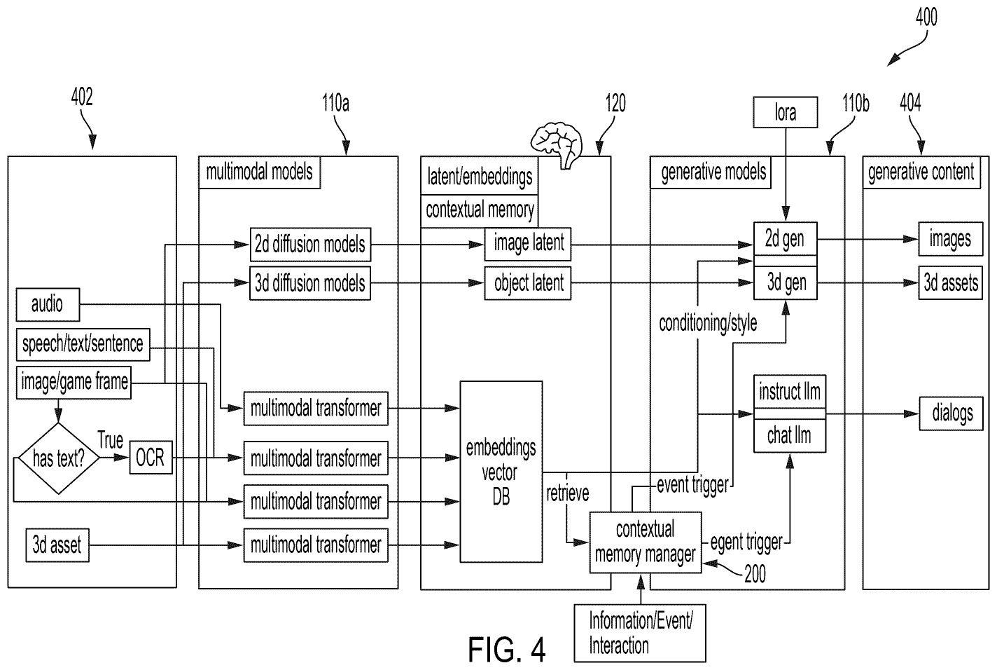

FIG. 4 illustrates system architecture 400 in accordance with disclosed implementations. Architecture 400 includes AI model 110, including multimodal models 110a and generative models 110b. As illustrated, multimodal models 110a include diffusion models and transformers. Generative AI models 110b include 2d and 3d image generation models as well as chat an instruction models. Architecture 400 also include input module 402 and output module 404.

In operation, input module 402 receives inputs. Assuming the example of a character in a game or metaverse environment, the input can include audio input graphics/image input text input and/or 3d asset input. This input is received by a character during, for example, gameplay and can be processed for input into multimodal models 110a. For example, text input can be subject to Optical Character Recognition (OCR) prior to being input into a multimodal model.

Multimodal models 110a process the inputs, in a known manner. the diffusion models generate 2d images and/3d objects, and the transformers can generate various vector embeddings. These images, objects and embeddings are stored in contextual memory 120 in the manner described above. The images and objects can be selectively fed to generative models 110b, as inputs or training data, to generate 2d and 3d content as output at output module 404. The embeddings can be selectively passed to generative AI models 110b, as inputs or training data, based on control of contextual memory manager.

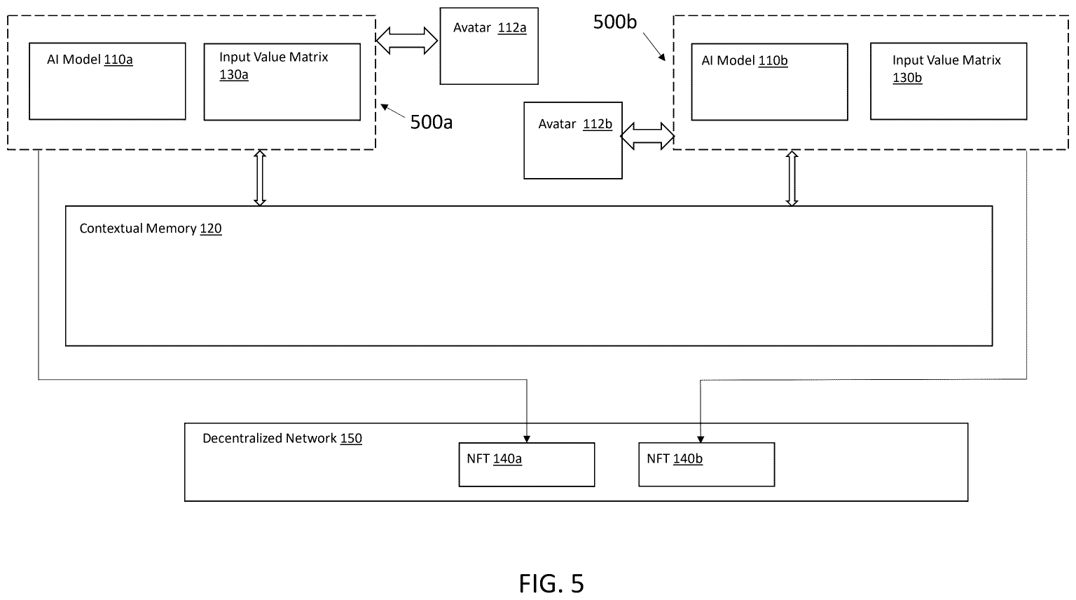

FIG. 5 illustrates a disclosed implementation in which a contextual memory is shared by multiple AI Agents. As shown in FIG. 5, data structure 500a of an AI agent includes AI model 110a, input value matrix 130a and avatar 112a. Similarly, a data structure 500b of an AI agent includes AI model 110b, input value matrix 130b and avatar 112b. AI Agents 500a and 500b can be configured to execute id the same or different execution environments. However, AI agent 500a and AI agent 500 share a contextual memory 120a. Each AI agent communicates can write to and read from contextual memory 120 through an interface layer provide by the execution environment(s).

Contextual memory 120 can physically be stored in a non-transient memory device that is located anywhere that allows access by the AI agents. The shared contextual memory allows multiple AI agents to cooperate to perform tasks. For example, the AI agents could represent characters in a game that draw upon each other's experience and/or actions. As another example, the AI agents could be financial bots that work together to analyze and purchase financial instruments.

A “murmur”, i.e., a data stream, can be any

Asset (be it an avatar character, NPC, wearable, consumable, environment, or location, among other examples) to instill awareness. As noted a the murmur can be stored as a card which follows a specific, standardized format containing information that the asset provides to the AI during interactions. This card data contributes to the pretext of the prompt, factoring in the distance between the asset and the agent, with a designated level of importance. Each card can also include fields to declare interactions with other assets.

Each Murmur possesses the capability to record interactions with other assets, constructing a dynamic, interconnected web of relationships and histories. This not only facilitates a nuanced understanding of the virtual world but also fosters the development of intricate, emergent behaviors and narratives as AIs navigate their environment, influenced by layers of surrounding metadata.

This enables objects, assets, and characters to attain a profound “comprehension” of their surroundings. For instance, objects might acquire traits from prolonged exposure to specific settings, such as becoming toxic if left in a hazardous environment and this in turn could effect another asset. As objects, avatars, and environments frequently interact, the murmurs between them strengthen, creating robust centralities and sharing more history and context. This establishes a data ecosystem beneath ownership and composability, forming an opaque layer that evolves and validates the primary spatial understanding of the metaverse collectively based on the actions chosen by the collective.

The contextual data can include the following data components:
User: Refers to the player, app user, or another application agent or smart contract interacting with both the experience and the AL
AI Represents the specific model engaged in interaction within the matrix.
Avatars: Digital representations embodying users or characters within the virtual environment Avatars play a crucial role in shaping interactions and experiences
Props: Denotes assets in the app or game containing a Murmur Card, transmitting information to both the AI and the user. For instance, a chest in a game or a can in a vending machine.
Areas: Similar to props, these regions have their own Murmur Card, but instead of specific objects, they encompass broader spaces. An example would be an area of a map or game where the player or the AI acquires specific properties.

A format of the card can include:
Display Name: Identifies the asset by name.
UID: Represents a constant, unique identifier for each specific asset.
   Keywords: Core descriptive terms associated with the asset, potentially utilized in the long-term memory system.
Importance: Assigns a priority factor to the asset, allowing the chatbot to prioritize information accordingly.
Content: Encompasses intrinsic information, serving as the primary description of the asset.
Dynamic Content: Refers to information that can be conveyed to the asset either by the user or the chatbot.
Deep content: Involves interaction information linking assets, with each linked asset having its own substructure:
UID: The unique identifier of the linked asset.
Rule: Specifies conditions for interaction between the two assets (e.g., proximity closer than 1 m or overlapping).
Action: Describes the information transmitted to the AI when the rule is met (e.g., chest opens, note appears with the location of a rare weapon).
Counter: Indicates the number of times the event can occur, if it reaches 0, the event ceases, if set to −1, the event can occur indefinitely.
Restrictive Prompting: Serves as a crucial mechanism for maintaining balance and narrative consistency by imposing limitations.

The contextual memory can be implemented in a wide range of ways. For example, the stored data can be decentralized and owned by the users, and transportable between applications and execution environments. As one example, date relating to emotions and personality can be stored, akin to storing other characteristics like speed or strength. This proves particularly beneficial for interactions, particularly when engaging with LLMs.

In essence, the disclosed implementations allow objects, wearables, weapons, locations, areas, characters, vehicles, and more to exhibit intelligence, fostering increased interoperability across a broader spectrum of AI models and functions. The disclosed implementations establish a platform that delivers essential elements for making intelligence both relevant and personal, allowing for ownership and portability.

To introduce an “emotional” dimension to this interoperability, disclosed implementations can extract emotional values, which can be associated with colors, introducing a pioneering approach to digital asset customization and interaction.

Each specific emotional connotation can be associated with a color and the color can be converted into a hexadecimal code. This code establishes a universal visual language for emotions within digital experiences in execution environments. This adds complexity to interactions, enhancing the unpredictability of emotional layers derived from the color spectrum. Referred to as the “Emotional Palette”, this innovation significantly enriches the uniqueness of AI agents, providing a more personalized experience across gaming and other applications. When applied to generative AI, such as generative music and generative 3D, the creation of content in the open metaverse or other execution environments, is enhanced.

Because the contextual memory is persistently associated with the AI agent, or multiple AI agents, the interactions and experiences, stored as contextual data, of the AI agent(s) can be transferable with the AI agent(s) across multiple execution environments. This means that the AI agent's learned behaviors, adaptations, and experiences can be preserved and carried over when the AI agent is transferred between different execution environments. This feature may enhance the continuity of experience for the AI agent, providing a more seamless and consistent user experience across different metaverse applications or platforms. As noted above, contextual memory manager 200 may operate in three distinct modes: 1) Space Matrix, 2) Event Matrix, and 3) Ubiquitous Matrix. These modes may be used to manage the interactions of the AI agent within the metaverse environment.

In the Space Matrix mode, information may be transmitted to the AI agent based on physical proximity in either a 2D or 3D space. For instance, in an open-world game, character movement may prompt information presentation based on their surroundings. This creates an immersive experience akin to “feeling a vibe” in the environment. Closer interactions evoke stronger sensations, influencing feelings of strength, agility, excitement, or even reflecting a brand's values. As one example, upon entering a dangerous area, the metadata exchange could cause the AI character/avatar to be apprehensive and more careful.

In the Event Matrix mode, information may be relayed to the AI agent upon an event trigger, such as a button click, user selection, or interaction with an object (e.g., being hit by a punch from another AI avatar, “exercising” in the metaverse environment, and the like). This mode allows for dynamic interactions within the metaverse environment, enhancing the user experience. As an example, an AI character could become temporarily disoriented upon being struck by a weapon or could become stronger after lifting heavy weights in a virtual gym.

In the Ubiquitous Matrix mode, information conveyed to the AI agent persists over time, representing the character's knowledge or memories. For example, in two different games or apps with distinct underlying Large Language Models (LLMs), if the avatar corresponding to an AI agent remains constant, each application comprehends the same history, backstory, and achievements associated with the agent. This mode can provide a sense of continuity and consistency across different metaverse applications, enhancing the user experience.

The contextual memory can store a variety of data types, including but not limited to, data representing the AI agent's actions, decisions, interactions with other AI agents or users, experiences within the execution environment, or other relevant contextual information. This data may be used to inform the AI agent's decision-making processes, influence its behaviors, and shape its interactions within the metaverse environment. The contextual memory may be configured to update dynamically based on the AI agent's ongoing interactions and experiences within the execution environment.

The contextual memory manager may be implemented in accordance with an “environment matrix”, a protocol that empowers the AI agents to comprehend 3D objects, avatars, and spaces. The environment matrix may facilitate the storage of events and interactions in 3D environments as long-term data, within contextual memories, that can propagate through contact, fostering shared consensus around knowledge and activities. The combination of the contextual memories and the environment matrix provides a comprehensive and dynamic system for managing AI agents in an execution environment. The environment matrix can operate in the modes discussed above (Space Matrix, Event Matrix, and Ubiquitous Matrix).

The AI agent's interactions with other elements in the execution environment are stored in the contextual memory through a dynamic process involving metadata exchange and object development. Every interaction-whether with Non-Player Characters (NPCs), other assets, or the environment itself-is processed through exchanges of metadata (referred to as “biotags”). These biotags are unique to each player and entity, evolving based on interactions. This allows for a detailed and personalized contextual memory for the AI agent, as every action and reaction contribute to the ongoing development of the object's metadata, influencing future interactions and behaviors.

By ensuring that metadata evolves according to personal engagements, the AI agent can deliver individualized experiences within each environment. This means the perception and responses of the AI agent are tailored to the unique history of interactions in each environment, allowing for a seamless transition of behaviors and narratives across different digital spaces, thereby enhancing the depth of engagement and experience.

The structure and content of the cards in the contextual memory are designed to encapsulate detailed metadata about each interaction, including the object's biotags, the nature of the interaction (e.g., dialogue, combat, transaction), and the emotional or contextual significance. These cards serve as dynamic memory units, continuously updated, and expanded with new interactions and experiences. They enable the AI agent to recall past interactions, predict future behaviors, and adjust its actions, accordingly, ensuring a rich, evolving narrative driven by player actions and interactions within the game world.

Contextual memory directly influences the emergent behaviors of the AI agent by serving as a foundation for learning and adaptation. As the AI processes and stores interactions within its contextual memory, it identifies patterns, preferences, and outcomes, leading to the development of new strategies, responses, and behaviors. This adaptive learning mechanism enables the AI agent to evolve, generating unpredictable and complex behaviors that contribute to a dynamic and immersive game world. The interplay between stored metadata and ongoing interactions fosters a cycle of continuous evolution and refinement of the AI agent's behavior, enhancing the game's depth and replay ability.

Consistent interpretation of the AI agent's attributes across multiple metaverse applications can be ensured through the integration of an open and p2p standardized metadata protocol. By storing key attributes and histories of interactions on this open data layer, data is immutable, secure, and universally accessible across different platforms. Users own the data related to their account and can permit applications to access that data. This uniform approach to data management allows for a seamless transition of AI agents and their attributes between different metaverse environments, ensuring that the core characteristics and learned behaviors remain intact and are interpreted consistently, regardless of the application or platform.

The environment matrix, the value matrix, and the contextual memory may work together to manage the AI agent's interactions within the metaverse environment. As noted above, the value matrix may define the attributes of the AI agent, while the contextual memory may store data associated with the AI agent based on interactions within the environment based on the environment matrix protocol. This combination provides a comprehensive and dynamic system for managing AI agents in a metaverse environment.

The various AI models can be of known construction. the diffusion models of disclosed implementations can be, known diffusion models that start with existing data (e.g., an image) and progressively add random noise to it. This noisy data is then transformed into a structured output. Diffusion models are trained to undo the noise addition step by step, gradually revealing the original content. This enables diffusion models to generate accurate and detailed content as outputs. For example, they can generate lifelike images or produce coherent text sequences.

The multimodal transformers of disclosed implementations can be conventional transformer in which a neural network architecture is designed to handle data from multiple modalities (such as text, images, and audio) simultaneously. Transformers use self-attention mechanisms to process sequences of tokens. One example is a Vision Transformer (ViT) which adapts transformers for image data by dividing an image into fixed-size patches and treating them as tokens. These transformers merge information from different modalities. For example, they can process both image patches and text tokens together. Techniques that can be used by the multimodal transformers include cross-modal attention and fusion processes.

A number of implementations have been described. Nevertheless, it will be understood that various modifications may be made without departing from the spirit and scope of the disclosure. Accordingly, other implementations are within the scope of the following claims.

What is claimed:

1. A computer-implemented method for creating artificial intelligence (AI) agents for execution in one or more execution environments, the method comprising:
linking a first AI agent with a first value matrix that defines attributes of the first AI agent configured for executing in a first computing execution environment to perform at least one task in the first computing execution environment;
linking a second AI agent with a second value matrix that defines attributes of the second AI agent configured for executing in a second computing execution environment to perform at least one task in the second computing execution environment;
providing a contextual memory, wherein the contextual memory is configured to store contextual data relating to experiences and/or emotions of the first AI agent in the first computing execution environment and experiences and/or emotions of the second AI agent in the second computing execution environment; and
providing an interface layer between each of the first AI agent and the second AI agent and the contextual memory to thereby allow the first AI agent and the second AI agent to share the contextual memory.

2. The computer-implemented method of claim 1, wherein the contextual data influences interactions of the first AI agent in the first computing execution environment and the second AI agent in the second computing execution environment.

3. The computer-implemented method of claim 2, wherein the contextual memory comprises a plurality of cards, each card containing data representing an interaction or attribute of a specific asset within at least one of the one or more execution environments.

4. The computer-implemented method of claim 3, wherein the data on the cards includes at least one of intrinsic information, dynamic information, and event information related to the specific asset.

5. The computer-implemented method of claim 4, wherein the card includes data indicating the following:
an asset identifier;
keywords associated with the asset;
an asset priority indicator;
intrinsic information describing the asset;
dynamic information conveyed a user or an AI agent;
interaction information linking assets; and
restrictive prompting data.

6. The computer implemented method of claim 1, wherein the first computing execution environment and the second computing execution environment are different computing execution environments whereby experiences and/or emotions are transferable between the first computing execution environment and the second computing execution environment.

7. The computer-implemented method of claim 1, wherein the contextual memory is dynamically updated based on the first AI agent's interactions and activities within the first computing execution environment and the second AI agent's interactions and activities within the second computing execution environment.

8. The computer-implemented method of claim 1, wherein an AI model of the first AI agent and an AI model of the second AI agent evolves over time through machine learning techniques that utilize the stored contextual data.

9. The computer-implemented method of claim 1, wherein the first computing execution environment and the second computing execution environment include at least one of virtual reality, augmented reality, and gaming platforms.

10. The computer-implemented method of claim 1, wherein the contextual data relates to real-world experiences of a human associated with the fist AI agent or the second AI agent.

11. The computer implemented method of claim 1, wherein the contextual data is stored as colors that represent emotions.

12. The computer-implemented method of claim 11, wherein the colors are represented as hexadecimal code.

13. The computer implemented method of claim 1, wherein at least one of the first AI agent and the second AI agent include a generative AI model.

14. The computer implemented method of claim 13, where the generative AI model is at least one of a generative music model and/or a generative 3D model.

15. A computer system for creating artificial intelligence (AI) agents for execution in one or more execution environments, the system comprising:
a computer hardware processor; and
a memory operatively coupled to the computer hardware processor and storing computer-executable instructions which, when executed by the computer hardware processor, cause the computer hardware processor to carry out a method comprising:
linking a first AI agent with a first value matrix that defines attributes of the first AI agent configured for executing in a first computing execution environment to perform at least one task in the first computing execution environment;
linking a second AI agent with a second value matrix that defines attributes of the second AI agent configured for executing in a second computing execution environment to perform at least one task in the second computing execution environment;
providing a contextual memory, wherein the contextual memory is configured to store contextual data relating to experiences and/or emotions of the first AI agent in the first computing execution environment and experiences and/or emotions of the second AI agent in the second computing execution environment; and
providing an interface layer between each of the first AI agent and the second AI agent and the contextual memory to thereby allow the first AI agent and the second AI agent to share the contextual memory.

16. The system of claim 15, wherein the contextual data influences interactions of the first AI agent in the first computing execution environment and the second AI agent in the second computing execution environment.

17. The system of claim 16, wherein the contextual memory comprises a plurality of cards, each card containing data representing an interaction or attribute of a specific asset within at least one of the one or more execution environments.

18. The system of claim 17, wherein the data on the cards includes at least one of intrinsic information, dynamic information, and event information related to the specific asset.

19. The system of claim 18, wherein the card includes data indicating the following:
an asset identifier;
keywords associated with the asset;
an asset priority indicator;
intrinsic information describing the asset;
dynamic information conveyed a user or an AI agent;
interaction information linking assets; and
restrictive prompting data.

20. The system of claim 15, wherein the first computing execution environment and the second computing execution environment are different computing execution environments whereby experiences and/or emotions are transferable between the first computing execution environment and the second computing execution environment.

21. The system of claim 15, wherein the contextual memory is dynamically updated based on the first AI agent's interactions and activities within the first computing execution environment and the second AI agent's interactions and activities within the second computing execution environment.

22. The system of claim 15, wherein an AI model of the first AI agent and an AI model of the second AI agent evolves over time through machine learning techniques that utilize the stored contextual data.

23. The system of claim 15, wherein the first computing execution environment and the second computing execution environment include at least one of virtual reality, augmented reality, and gaming platforms.

24. The system of claim 15, wherein the contextual data relates to real-world experiences of a human associated with the fist AI agent or the second AI agent.

25. The system of claim 15, wherein the contextual data is stored as colors that represent emotions.

26. The system of claim 25, wherein the colors are represented as hexadecimal code.

27. The system of claim 15, wherein at least one of the first AI agent and the second AI agent include a generative AI model.

28. The system of claim 27, where the generative AI model is at least one of a generative music model and/or a generative 3D model.
